(19) United States
(12) Patent Application Publication
(10) Pub. No.: US 2025/0381873 A1
(43) Pub. Date: Dec. 18, 2025

(54) CHARGING SYSTEM FOR CHARGING A HIGH-VOLTAGE BATTERY OF A VEHICLE AND METHOD OF CONTROLLING THE CHARGING SYSTEM

(71) Applicant: VOLVO TRUCK CORPORATION, Göteborg (SE)

(72) Inventor: Mats NYSTRÖM, Torslanda (SE)

(73) Assignee: VOLVO TRUCK CORPORATION, Göteborg (SE)

(21) Appl. No.: 18/877,738

(22) PCT Filed: Jun. 30, 2022
(86) PCT No.: PCT/EP2022/068198

§ 371 Date: Dec. 20, 2024

(51) Int. Cl. B60L 53/62; B60L 3/04; B60L 53/16

(52) U.S. Cl. CPC B60L 53/62; B60L 3/04; B60L 53/16; B60L 2200/36; B60L 2240/547; B60L 2240/549; B60L 2270/20

(57) ABSTRACT

The present disclosure relates to a charging system (100) for charging a high-voltage battery of a vehicle (300), the charging system comprising: a charging inlet (102) configured to be connected to a high-voltage power source (104); a high-voltage battery (106); a contactor (108) arranged between the charging inlet and the high-voltage battery; a diode (110) arranged between the contactor and the charging inlet, wherein the diode is configured to block a current from the high-voltage battery to the charging inlet; and a charging system control unit (112) configured to: set a charging voltage of the high-voltage power source to a voltage lower than a battery voltage; close the contactor; increase the charging voltage to a first charging voltage higher than the battery voltage but lower than a final charging voltage; detect a charging current; and set a charging voltage from the high-voltage power source to the final charging voltage.

### TECHNICAL FIELD

The invention relates to a charging system for an electrical vehicle. In particular, the invention relates to a charging system and method for reducing contactor wear when initiating charging of a battery by a high-voltage power source.

The invention is applicable in electrical and hybrid vehicles within the fields of trucks, buses, industrial construction machines and the like. Although the invention will be described with reference to a truck, the invention is not restricted to this particular vehicle, but may also be used in other electric vehicles.

### BACKGROUND

In hybrid and electric vehicles, charging of batteries is an essential function which is expected to be reliable and safe. The inlet of the vehicle charging system used for charging batteries of a vehicle shall according to safety regulations be electrically disconnected when no charging station is connected to eliminate the risk that the battery voltage is present at the charging inlet. For the purpose of disconnection, a contactor is typically used.

However, contactors are sensitive to inrush currents occurring when the contactor is being closed when at the same time a voltage is applied over the contactor, such as the charging voltage for a battery. In particular, each time a contactor is exposed to a high inrush current, some wear of the contactor will occur and after multiple exposures to high inrush currents the contactor may fail and may need to be replaced. A contactor with a high degree of wear may also be a safety concern sine its capability to disconnect in an emergency shut down situation may be impaired.

A known solution to reduce contactor wear is to control the voltage over the contactor in an attempt to set it as low as possible before closing the contactor. However, accurate voltage control requires accurate voltage measurement which can be a problem since already a quite small voltage difference may result in a high inrush current. Preferably, the voltage over the contactor should be less than 2-3 V to eliminate contactor wear and such accurate voltage control is both complicated and expensive to implement and a voltage measurement device may need individual calibration.

Accordingly, there is a need for an improved system and method for reducing contactor wear in a charging system of a vehicle.

### SUMMARY

An object of the claimed system and method is to provide an improved charging system for charging a high-voltage battery of a vehicle and a method for controlling the charging system which reduces contactor wear and thereby improves the reliability of the charging system.

According to a first aspect, there is provided a charging system for charging a high-voltage battery of a vehicle. The charging system comprises: a charging inlet configured to be connected to a high-voltage power source; a high-voltage battery; a contactor arranged between the charging inlet and the high-voltage battery; a diode arranged between the contactor and the charging inlet, wherein the diode is configured to block a current from the high-voltage battery to the charging inlet; and a charging system control unit. The charging system control unit is configured to: set a charging voltage of the high-voltage power source to a voltage lower than a battery voltage; close the contactor; increase the charging voltage to a first charging voltage higher than the battery voltage but lower than a final charging voltage; detect a charging current; and set a charging voltage from the high-voltage power source to the final charging voltage.

The present invention is based on the realization that contactor wear can be reduced by ensuring that the voltage over the contactor is as low as possible, and ideally zero, when the contactor is closed to initiate charging of the high-voltage battery. The diode arranged between the contactor and the charging inlet prevents a reverse current from the battery to the charging inlet which in turn allows the charging voltage from the charging station to initially be set at a voltage lower than the battery voltage. Thereby, there is no inrush current through the contactor when the contactor is being closed which eliminates the risk of arcing and also reduces contactor wear. After closing the contactor, the voltage from the high-voltage power source is being increased to a first charging voltage which is lower than a final charging voltage which reduces the inrush current through the diode compared to if the voltage was to be set directly to the charging voltage, again protecting the contactor which may otherwise be damaged by repeated exposure to high inrush currents.

Moreover, the described system is configured to detect a charging current before setting the charging voltage from the power source to the final charging voltage. It can thereby be determined that charging of the battery is initiated and that there are no faults in the system preventing charging before the final charging voltage is being set. Accordingly, if there is a fault in the system, the system is not exposed to the maximum charging voltage. Instead charging can be aborted and the fault resolved with a reduced risk of damaging the system.

According to an example embodiment, the control unit is further configured to limit the current to the battery to a current below a predetermined charging current until a charging current is detected. In practice, limiting the current to the battery comprises limiting the voltage over the battery. Limiting the current further reduces the risk of damage to the system in case of a fault in the system. If no charging current is detected even though the charging voltage is higher than the battery voltage, charging can be aborted before the battery is subjected to a maximum charging current.

According to an example embodiment, the control unit is further configured to stop an increase in voltage once a predetermined charging current is reached. The charging conditions are thereby set by a maximum allowed charging current measured in the battery.

According to a second aspect, there is provided a method for controlling a charging system for charging a high-voltage battery of a vehicle. The charging system comprising: a charging inlet configured to be connected to a high-voltage power source; a high-voltage battery; a contactor arranged between the charging inlet and the high-voltage battery; a diode arranged between the contactor and the charging inlet, wherein the diode is configured to block a current from the high-voltage battery to the charging inlet; and a charging system control unit. The method comprises: setting a charging voltage of the high-voltage power source to a voltage lower than a battery voltage; closing the contactor; increasing the charging voltage to a first charging voltage higher than the battery voltage but lower than a final charging voltage; detecting a charging current; and setting a charging voltage from the high-voltage power source to the final charging voltage.

According to an example embodiment, closing the contactor comprises simultaneously closing a first switch arranged between a positive pole of the charging inlet and a positive pole of the battery, and a second switch arranged between a negative pole of the charging inlet and a negative pole of the battery. An advantage of closing both of the switches simultaneously is that only one step is required for initiating the charging, thereby simplifying control of the system.

According to an example embodiment, closing the contactor comprises first closing a second switch arranged between a negative pole of the charging inlet and a negative pole of the battery followed by closing a first switch arranged between a positive pole of the charging inlet and a positive pole of the battery.

There is also provided a control unit arranged and configured to perform the above described method for controlling the safety circuit.

Further effects and features of this second aspect of the present invention are largely analogous to those described above in connection with the first aspect of the invention.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a schematic illustration of charging system in a vehicle according to an embodiment of the invention;

FIG. 2 is a flow-chart outlining a method of controlling a charging system of a vehicle according to an embodiment of the invention, and

FIG. 3 is a vehicle comprising a power system according to an embodiment of the invention.

### DETAILED DESCRIPTION OF EXAMPLE EMBODIMENTS OF THE INVENTION

In the present detailed description, various embodiments of a charging system for charging a high-voltage battery of a vehicle according to the present invention are mainly discussed with reference to a charging system in a truck. It should however be noted that this by no means limits the scope of the present invention since the described invention is equally applicable in other types of vehicles such as cars, buses and construction vehicles. The described charging system may also be used in marine applications such as boats and ships, and in other applications comprising a high-voltage battery to be charged.

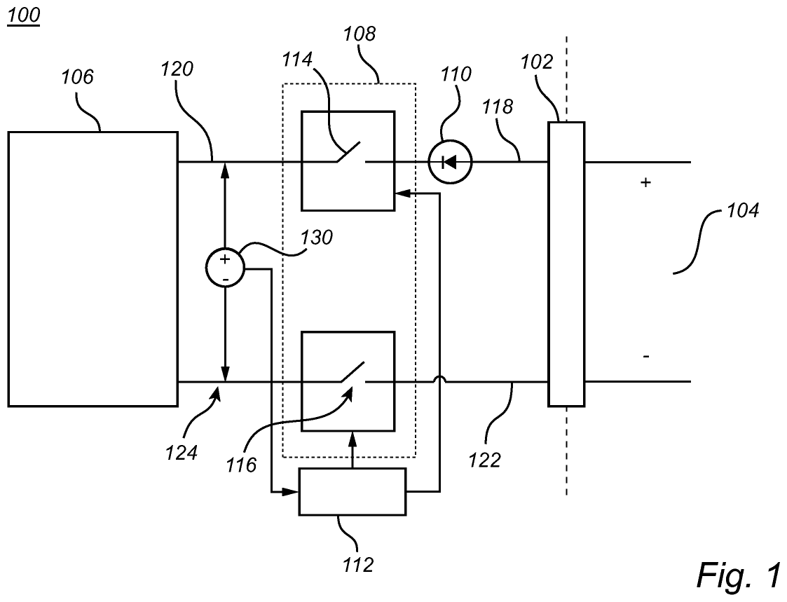

FIG. 1 schematically illustrates a circuit schematic of a charging system 100 for charging a high-voltage battery of a vehicle 300. The charging system comprises a charging inlet 102 configured to be connected to a high-voltage power source 104. The high-voltage power source 104 can be a stationary charging station connected to the power grid, but the power source can also be another power source such as an external battery or a power source in another vehicle. In the following description, the high-voltage power source 104 will generally be referred to as a charging station 104.

The charging system 100 further comprises a high-voltage battery 106, a contactor 108 arranged between the charging inlet 104 and the high-voltage battery 106, a diode 110 arranged between the contactor 108 and the charging inlet 104, wherein the diode 110 is configured to block a current from the high-voltage battery 106 to the charging inlet 104 and a charging system control unit 112. The contactor 108 is here illustrated to comprise two separate switches 114, 116, a first switch 114 arranged between a positive pole 118 of the charging inlet 102 and a positive pole 120 of the battery 106 and a second switch 116 arranged between a negative pole 122 of the charging inlet 102 and a negative pole 124 of the battery 106. The first and second switches 114, 116 can be controlled either individually or jointly as one switch.

Moreover, the charging system control unit 112 is arranged to control the first and second switches 114, 116 of the contactor 108 and also to provide commands to the charging station 104 requesting a charging voltage. The charging system control unit 112 is also connected to the battery 106 or at least to a current measurement unit arranged and configured to measure a current through the battery 106 so that the battery current is known to the charging system control unit 112.

The charging system control unit 112 may include a microprocessor, microcontroller, programmable digital signal processor or another programmable device. The control unit may also, or instead, include an application specific integrated circuit, a programmable gate array or programmable array logic, a programmable logic device, or a digital signal processor. Where the control unit includes a programmable device such as the microprocessor, microcontroller or programmable digital signal processor mentioned above, the processor may further include computer executable code that controls operation of the programmable device.

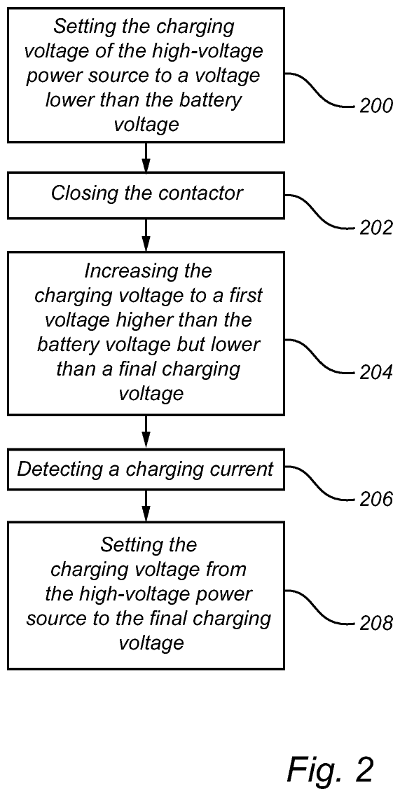

FIG. 2 is a flow chart describing steps of a method for controlling the charging system 100 according to an example embodiment, and the method will be described with reference to the charging system 100 illustrated in FIG. 1.

In a first step, the control unit 112 is configured to set 200 a charging voltage of the charging station 104 to a voltage lower than a battery voltage. At this stage, the voltage provided by the charging station is preferably at least 50 V lower than the battery voltage. This assumes both that the battery voltage is known and that the control unit 112 can communicate with and send commands to the charging station 104. The battery voltage is typically known in a power system of a vehicle as indicated by the voltage measurement unit 130 in FIG. 1 which is arranged to measure a voltage over the battery 106.

The charging system 100 may optionally comprise a second voltage measuring unit (not shown) arranged to measure the voltage provided from the charging station 104, i.e. the voltage over the charging inlet 102. However, here it is assumed that a voltage measurement is provided by the charging station and that the voltage measurement can be considered to be reliable.

Next, the contactor 108 is being closed 202 by a command from the control unit 112 so that an electrical connection is formed between the charging inlet 102 and the battery 106. In an example embodiment, closing the contactor 108 comprises simultaneously closing the first switch 114 and the second switch 116. However, the step of closing the contactor 108 may also comprise first closing the second switch 116 of the negative pole followed by closing the first switch 114 of the positive pole.

The battery system is by nature floating with galvanic separation from the vehicle chassis. When the charging station 104 is connected to the charging inlet 102 the chassis is connected to the grid ground potential (protective earth). However, since the battery system is floating, a control system powered by the vehicle low voltage supply with chassis as 0 V need to measure on both poles of the battery system to be able to estimate the battery voltage.

The supply charging voltage provided by the charging station 104 is typically not floating but in both cases, it is required that both poles are connected to close a circuit and start charging. When the first pole (typically the negative) is connected separately no charging circuit is yet closed but due to pole to chassis capacitance (and possibly other high impedance leaks) a transient will occur even though it may be of low energy (less than 100 mJ) and the duration is also short due to the capacitive nature of the system.

When one pole is connected to the charging station 104 the complete charging system will have the same voltage potential reference and hence as soon as the forward voltage of the diode is overcome the voltage on both sides of the diode is known by measuring on one of the sides (the current flow will be measured by the battery).

Since the voltage of the charging station 104 is set to be lower than the battery voltage when the contactor is closed, it is the diode 110 that prevents a current from flowing from the battery 106 to the charging station 104. In practice, there may be a minor current through the diode 110 corresponding to the reverse bias leakage current but that can be seen as negligible in the present context.

Once the contactor 108 is closed, the charging system control unit 112 orders the charging station 104 to increase 204 the charging voltage to a first charging voltage higher than the battery voltage but lower than a final charging voltage. The charging voltage may be increased in steps such that the voltage is stepped from the initial voltage to the first charging voltage, or the voltage may be increased in a continuous ramp where an example ramp rate is 100 V/s and a final charging voltage can be for example 400 V or 800 V.

When the voltage at the inlet 102 exceeds the battery voltage, and the forward voltage drop of the diode 110, a charging current can be detected 206. However, if no charging current is detected even though the charging voltage exceeds the battery voltage, there may be a fault in the system and charging can be aborted. The charging current can be detected by a current measurement unit in the battery as such, but it would also be possible to use a current measurement unit arranged outside of the battery. The current measurement unit is thus configured to provide a confirmation that a charging current is detected to the charging system control unit 112, for example by continuously reporting a battery current to the charging system control unit 112.

The charging system control unit 112 can further be configured to limit the current to the battery 106 to a current below a predetermined charging current until a charging current is detected. Limiting the current is in practice done by limiting the input voltage since the battery resistance can be assumed to be known, at least implicitly through the relation between a battery voltage and a battery current. The charging system can thus be controlled to limit a charging voltage to a predetermined intermediate charging voltage until a charging current is detected. The charging system control unit 112 can further be configured to stop an increase in voltage once a predetermined charging current is reached, even if the first charging voltage is not reached.

The final step comprises setting 208 a charging voltage from the charging station 104 to the final charging voltage. The described system and method thereby act to minimize the voltage difference over the contactor 108 when the contactor is being closed 108 in order to minimize the current inrush and the resulting contactor wear. The system is thereby more reliable and the need for replacing or servicing the contactors is reduced.

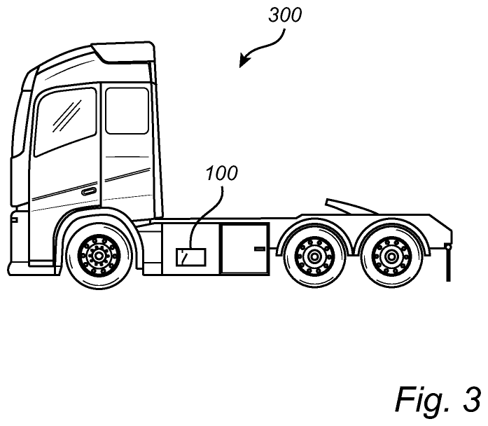

FIG. 3 schematically illustrate a vehicle 300 comprising a charging system 100 according to any of the aforementioned embodiments and examples.

It is to be understood that the present invention is not limited to the embodiments described above and illustrated in the drawings; rather, the skilled person will recognize that many changes and modifications may be made within the scope of the appended claims.

1. A charging system for charging a high-voltage battery of a vehicle, the charging system comprising:
a charging inlet configured to be connected to a high-voltage power source;
a high-voltage battery;
a contactor arranged between the charging inlet and the high-voltage battery;
a diode arranged between the contactor and the charging inlet, wherein the diode is configured to block a current from the high-voltage battery to the charging inlet; and
a charging system control unit configured to:
set a charging voltage of the high-voltage power source to a voltage lower than a battery voltage;
close the contactor;
increase the charging voltage to a first charging voltage higher than the battery voltage but lower than a final charging voltage;
detect a charging current; and
set a charging voltage from the high-voltage power source to the final charging voltage.

2. The charging system according to claim 1, wherein the battery comprises a current measurement unit configured to measure a charging current of the battery.

3. The charging system according to claim 2, wherein the current measurement unit is configured to provide a confirmation that a charging current is detected to the control unit.

4. The charging system according to claim 1, wherein the charging system control unit is further configured to limit the current to the battery to a current below a predetermined charging current until a charging current is detected.

5. The charging system according to claim 1, wherein the control unit is further configured to stop an increase in voltage once a predetermined charging current is reached.

6. The charging system according to claim 1, wherein the contactor comprises a first switch arranged between a positive pole of the charging inlet and a positive pole of the battery, and a second switch arranged between a negative pole of the charging inlet and a negative pole of the battery.

7. A vehicle comprising a charging system according to claim 1.

8. Method for controlling a charging system for charging a high-voltage battery of a vehicle, the charging system comprising: a charging inlet configured to be connected to a high-voltage power source; a high-voltage battery; a contactor arranged between the charging inlet and the high-voltage battery; a diode arranged between the contactor and the charging inlet, wherein the diode is configured to block a current from the high-voltage battery to the charging inlet; and a charging system control unit, wherein the method comprises:
Setting a charging voltage of the high-voltage power source to a voltage lower than a battery voltage;
closing the contactor;
increasing the charging voltage to a first charging voltage higher than the battery voltage but lower than a final charging voltage;
detecting a charging current; and
setting a charging voltage from the high-voltage power source to the final charging voltage.

9. The method according to claim 8, further comprising setting the charging voltage of the power source to at least 50 V below the battery voltage.

10. The method according to claim 8, further comprising providing a confirmation from a current measurement unit of the battery that a charging current is detected to the control unit.

11. The method according to claim 8, further comprising limiting the current from the charging station a current below a predetermined charging current until detecting a charging current.

12. The method according to claim 8, further comprising stopping an increase in charging voltage once a predetermined charging current is reached.

13. The method according to claim 8, wherein closing the contactor comprises simultaneously closing a first switch arranged between a positive pole of the charging inlet and a positive pole of the battery, and a second switch arranged between a negative pole of the charging inlet and a negative pole of the battery.

14. The method according to claim 8, wherein closing the contactor comprises first closing a second switch arranged between a negative pole of the charging inlet and a negative pole of the battery followed by closing a first switch arranged between a positive pole of the charging inlet and a positive pole of the battery.

15. A control unit for controlling a safety circuit for a power system of a vehicle, the control unit being configured to perform the steps of the method according to claim 8.
